(19) United States
(12) Patent Application Publication
(10) Pub. No.: US 2026/0193745 A1
(43) Pub. Date: Jul. 9, 2026

(54) METHODS TO PRODUCE HIGH STRENGTH ALUMINUM AND HIGH-STRENGTH ALUMINUM ARTICLES PRODUCED THEREFROM

(71) Applicant: VIRGINIA TECH INTELLECTUAL PROPERTIES, INC., Blacksburg, VA (US)

(72) Inventors: Jake YODER, Christiansburg, VA (US); Greg HAHN, Blacksburg, VA (US); Hang Z. YU, Blacksburg, VA (US)

(21) Appl. No.: 19/130,883

(22) PCT Filed: Nov. 17, 2023
(86) PCT No.: PCT/US2023/080397

§ 371 Date: May 16, 2025

Related U.S. Application Data
(60) Provisional application No. 63/426,242, filed on Nov. 17, 2022.

(51) Int. Cl. C22C 21/10; B21C 23/00; B23K 20/12; B23K 103/10; B33Y 10/00; B33Y 40/20; C22F 1/053

(52) U.S. Cl. CPC C22C 21/10; B21C 23/002; B23K 20/1215; B23K 20/122; B33Y 10/00; B33Y 40/20; C22F 1/053; B23K 2103/10

(57) ABSTRACT

Methods of making high-strength aluminum and high-strength aluminum articles made therefrom are provided. The methods include high strain rate severe plastic deformation (SPD) process applied to aluminum alloys containing aluminum and one or more of copper, magnesium, and zinc and being substantially free of chromium, zirconium, and manganese.

### CROSS-REFERENCE TO RELATED APPLICATIONS

This application is a 35 U.S.C. § 371 national stage application of PCT Application No. PCT/US2023/080397, filed Nov. 17, 2023, where the PCT claims priority to, and the benefit of, U.S. provisional application entitled “METHOD TO PRODUCE HIGH STRENGTH ALUMINUM” having Ser. No. 63/426,242 filed Nov. 17, 2022, the contents of which are incorporated by reference herein in their entireties.

### STATEMENT REGARDING FEDERALLY SPONSORED RESEARCH OR DEVELOPMENT

This invention was made with government support under Grant No. W911NF-19-2-0320 awarded by the Army Research Laboratory. The government has certain rights in the invention.

### TECHNICAL FIELD

The present disclosure generally relates to aluminum alloys and methods of making aluminum alloys.

### BACKGROUND

Research and development in lightweight high-strength metal alloys has been a dynamic and evolving field, driven by the ever-increasing demand for materials that offer superior strength-to-weight ratios. High-strength alloys, particularly high-strength aluminum alloys, have garnered significant attention for their potential to revolutionize industries such as aerospace, automotive, defense, and consumer electronics. Some good examples are in the aerospace sector, where high-strength aluminum alloys like 7075-T6 and 2024-T3 are used extensively in aircraft construction. These alloys provide the necessary structural integrity while keeping the overall weight of the aircraft to a minimum, contributing to enhanced fuel efficiency and range. In the automotive industry, high-strength aluminum alloys, such as 6000 series alloys, have been adopted for components like chassis and body panels. These alloys help reduce the weight of vehicles, leading to improved fuel economy and better performance. Electric vehicles (EVs) have particularly benefited from the use of high-strength aluminum alloys due to their lightweight nature, helping to extend battery range.

However, despite their numerous advantages, challenges persist in the development and utilization of high-strength alloys. One significant hurdle is the limited weldability of some high-strength aluminum alloys. Traditional welding techniques often result in defects, such as porosity and cracking, which compromise the integrity of the welded joint. To address this issue, ongoing research is focused on developing new welding processes and technologies that can effectively join otherwise non-weldable high-strength alloys. Techniques like Friction Stir Welding (FSW), Laser Beam Welding (LBW), and Electron Beam Welding (EBW) are being explored to create strong, defect-free welds in these materials.

To further advance the field of lightweight high-strength metal alloys, continued research and development efforts are essential. Additional research and development is needed to explore improved alloy compositions, advanced manufacturing methods, and innovative welding techniques that not only enhance material properties but also ensure the integrity of joints. Additionally, sustainability and cost-effectiveness are critical aspects that demand attention, as the adoption of these alloys in various industries continues to grow. Meeting these challenges will not only pave the way for more widespread utilization of high-strength alloys but also contribute to the development of more efficient and environmentally friendly technologies across a range of applications.

Thus, there is a need for additional research and development to unlock the full potential of lightweight high-strength metal alloys and address the evolving needs of modern society.

### SUMMARY OF THE DISCLOSURE

In various aspects, the present disclosure provides methods of forming articles from high-strength aluminum alloy using a high strain rate severe plastic deformation (SPD) process without the anticipated tradeoff in material strength. The methods and articles described in the present disclosure overcome many of the deficiencies with prior alloys and methods of making articles from alloys, for example the present disclosure provides methods of making articles with high strength alloys using the high strain rate SPD processes wherein the aluminum alloy is substantially free of a metal selected from the group consisting of chromium, zirconium, and manganese.

In various aspects, the disclosure provides a method of forming a metal article, the method including subjecting an aluminum alloy to a high strain rate severe plastic deformation (SPD) process to form a prefinished article; and heating the prefinished article to an elevated temperature for a period of time to form the article; wherein the aluminum alloy is a high-strength aluminum alloy containing aluminum and one or more of copper, magnesium, and zinc; and wherein the aluminum alloy is substantially free of a metal selected from the group consisting of chromium, zirconium, and manganese.

In further aspects, the disclosure provides articles formed by the high strain rate severe plastic deformation (SPD) process using a high-strength aluminum alloy containing aluminum and one or more of copper, magnesium, and zinc; and wherein the aluminum alloy is substantially free of a metal selected from the group consisting of chromium, zirconium, and manganese.

Other systems, methods, features, and advantages of methods and articles will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graph of the stress (MPa) versus strain (%) behavior of as-printed properties of Al-7075.

FIG. 2 is a graph of the stress (MPa) versus elongation (%) behavior of Al-7075 T6 after AFSD.

FIG. 3A is a Transmission Electron Microscopy (TEM) image of a dispersoid particle in a grain interior. FIG. 3B is a TEM image of the precipitation at a grain boundary.

FIG. 4 is a graph of the stress (MPa) versus elongation (%) behavior of dispersoid free Al-7075.

FIGS. 5A-5C are bar graphs of the yield strength (MPa) following air and water quenching after AFSD for as-received AA7050 and AA7075 (FIG. 5A), for featureless printed as-received AA7050 and AA7050 with no Zr (FIG. 5B), and for protrusion prints as-received AA7050 and AA7050 with no Zr (FIG. 5C).

### DETAILED DESCRIPTION

Severe plastic deformation processes refer to a class of processes that cause large strain and grain refinement via recrystallization either by dynamic means during processing or by static means during subsequent heating. The benefits of plastic deformation for forming and producing metallic components has been known in the form of forging. Recent advances have produced processes that can apply higher strains under more controlled conditions such as High-Pressure Torsion (HPT), Equal Channel Angular Pressing (ECAP), or Multidirectional Forging (MF). These processes deliver a large degree of plastic deformation over a relatively large timeframe meaning the shear strain rate is low. An emerging class of processes are being developed which use the friction stir principle; using frictional force and heat generation to plasticize materials in the solid-state. These processes include Friction Stir Welding (FSW), Friction Stir Extrusion (FSE), and Additive Friction Stir Deposition (AFSD). Leveraging the friction stir principle to plasticize and cause deformation relies on inherently high strain rates. The solid-state nature of these processes allows for it to be utilized on previously difficult to process materials such as the high strength aluminums of the 6xxx and 7xxx series.

Without reliance on any one theory the 7xxx series aluminum alloys may be strengthened via nanoscale metastable precipitates that inhibit motion of dislocations and increase strength. To achieve the peak strength of these alloys, specific heat treatments may be followed to ensure the proper dispersion and volume fraction of these precipitates. The strengthening precipitates are formed by first quenching from a solid solution followed by the creation of GP zones which evolve into the final strengthening precipitate. These processes are temperature sensitive, exposure of a fully strengthened part to high temperatures will degrade the strength rapidly. Thermomechanical processes such as those that rely on the friction stir principle will inherently degrade the precipitate structure. Even more interesting is that after high strain rates like that experienced during friction stir processing the peak properties cannot be regained. After heat treating to try and regain the full strength of a processed part, the ductility in the original material is lost. This is exemplified in Ref (1), where Al 7075 was subjected to FSW followed by a post process heat treatment. This series of steps showed a significant loss in ductility. This loss is detrimental to the viability of any component that has undergone processing via SPD.

Despite advances in alloy research, there is still a scarcity of alloys that retain the needed ductility and tensile strength after severe plastic deformation.

In various aspects, the disclosure provides a method of forming a metal article, the method including subjecting an aluminum alloy to a high strain rate severe plastic deformation (SPD) process to form a prefinished article; and heating the prefinished article to an elevated temperature for a period of time to form the article; wherein the aluminum alloy is a high-strength aluminum alloy containing aluminum and one or more of copper, magnesium, and zinc; and wherein the aluminum alloy is substantially free of a metal selected from the group consisting of chromium, zirconium, and manganese.

In further aspects, the disclosure provides articles formed by the high strain rate severe plastic deformation (SPD) process using a high-strength aluminum alloy containing aluminum and one or more of copper, magnesium, and zinc; and wherein the aluminum alloy is substantially free of a metal selected from the group consisting of chromium, zirconium, and manganese.

Although any methods and materials similar or equivalent to those described herein can also be used in the practice or testing of the present disclosure, the preferred methods and materials are now described. Functions or constructions well-known in the art may not be described in detail for brevity and/or clarity. Aspects of the present disclosure will employ, unless otherwise indicated, techniques of material science, metallurgy, corrosion science and engineering, mechanical engineering, aerospace and automotive engineering, welding science, and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and the range less than ‘y’. The range can also be expressed as an upper limit e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some aspects, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

The disclosure has been organized with aide of various section headings, which are used for convenience and readability, and should not be construed in any way as limiting the disclosure or the scope of the claims. The claims may, in some instances, incorporate aspects that fall under different section headings and such combinations of aspects are understood to be encompassed by the instant disclosure.

The disclosure will be better understood with the aid of certain definitions and prescribed methods, which are described in detail in the sections entitled Definitions and Methods. Other terms and methods may be described elsewhere in the disclosure, including in the Examples, and yet others will be understood by those skilled in the art upon reading the disclosure provided herein. All definitions and methods described herein should be understood to control over dictionary definitions, definitions in documents incorporated by reference, and/or ordinary meanings of the defined terms.

### Methods of Forming Metal Articles

In various aspects, methods are provided for forming a metal article, the methods including subjecting an aluminum alloy to a high strain rate severe plastic deformation (SPD) process to form a prefinished article; and heating the prefinished article to an elevated temperature for a period of time to form the article. The methods can include wherein the aluminum alloy is a high-strength aluminum alloy such as those containing one or more of copper, magnesium, and zinc. In some aspects, the aluminum alloy is substantially free of dispersoid particles. In some aspects, the aluminum alloy is substantially free of a metal selected from the group consisting of chromium, zirconium, and manganese.

### High Strain Rate Severe Plastic Deformation (SPD) Processes

High strain rate severe plastic deformation (SPD) processes are advanced manufacturing techniques used to enhance the mechanical properties of metal alloys, such as aluminum, through the application of extremely high deformation rates and strains. These processes aim to refine the microstructure of materials, resulting in improved strength, hardness, and other desirable properties. Examples of SPD processes include Friction Stir Welding (FSW), Friction Stir Extrusion (FSE), and Additive Friction Stir Deposition (AFSD).

High strain rate severe plastic deformation (SPD) processes are distinct from other manufacturing processes primarily due to their unique characteristics and the way they achieve microstructural refinement and property enhancement in materials.

SPD processes operate in the solid state, meaning they do not involve melting the feedstock material. Instead, SPD processes rely on plastic deformation at elevated temperatures (typically below the melting point of the alloy) to refine the microstructure. This is in contrast to traditional casting processes, which often involve melting and subsequent solidification. In some aspects, the elevated temperature of the SPD process is elevated temperature is from about 25° C. to about 600° C., about 25° C. to about 400° C., about 80° C. to about 600° C., about 80° C. to about 400° C., about 400° C. to about 600° C., or about 200° C. to about 500° C.

SPD processes subject materials to extremely high deformation rates and strains, far exceeding what is typically encountered in conventional manufacturing methods. These rapid deformations are achieved through various means, such as intense shear, pressure, or a combination of both. In some aspects, the SPD processes exhibit deformation rates of about 50 mm/min to about 500 mm/min, or about 100 mm/min to about 500 mm/min. In the case of angular deformation, the deformation rates can be, for example, 0.1 s⁻¹ to 10 s⁻¹. In some aspects, the SPD processes exhibit strains ranging from 0.5 to 10 (50% to 1000%), 1 to 10 (100% to 1000%), 1 to 8 (100% to 800%), 1 to 4 (100% to 400%), or more.

These SPD processes offer various methods to enhance the properties of metal alloys, making them particularly useful in industries that require lightweight, high-strength materials, such as aerospace, automotive, and structural engineering. As demonstrated herein, these approaches may result in loss of mechanical properties in high-strength aluminum alloys unless specific precautions described herein are observed.

### Friction Stir Welding (FSW)

In FSW, a rotating, specially designed tool with a threaded pin and a shoulder is inserted between the two pieces of material to be joined. The tool is plunged into the joint line and starts rotating at high speeds. As it rotates, it generates frictional heat and mechanical deformation in the material without reaching its melting point. This plasticizes the material, making it soft and malleable.

The rotating tool then moves along the joint line, effectively stirring and mixing the plasticized material from both sides. This results in a solid-state weld with a strong metallurgical bond. The temperature of the material remains below its melting point throughout the process.

The rotation speed of the FSW tool can range from 500 to 2000 RPM, depending on the alloy, thickness, and desired weld properties. Higher speeds are often used for thicker materials. Traverse speed determines how quickly the FSW tool moves along the joint line. It is typically in the range of 50 mm/min to 500 mm/min (2 in/min to 20 in/min) for aluminum alloys. Slower traverse speeds may be used for thicker materials. The design of the FSW tool, including the shape and dimensions of the pin and shoulder, can be tailored to the specific application. Tool geometry affects the heat generation, material mixing, and weld quality. The tool tilt angle can be adjusted to control the material flow and the properties of the weld. It is typically set between 1° and 3° for aluminum alloys. FSW can be used for a wide range of material thicknesses. It is particularly suitable for joining materials in the thickness range of 1 mm to 30 mm (0.04 in to 1.18 in) for aluminum alloys.

### Friction Stir Extrusion (FSE)

Friction Stir Extrusion (FSE) is an advanced solid-state manufacturing process used for shaping and joining materials, with a particular focus on aluminum alloys. FSE involves a rotating, specially designed tool with a threaded pin and a shoulder. The workpiece consists of a cylindrical billet made of the material you want to extrude and shape, such as an aluminum alloy. The tool is inserted into the cylindrical billet, and it starts rotating at high speeds. As the tool rotates, it generates frictional heat and mechanical deformation in the material without reaching its melting point. This plasticizes the material, making it soft and malleable. After plasticization, the plasticized material is forced through a shaped die, which determines the final cross-sectional shape of the extruded product. The combination of plastic deformation and extrusion through the die results in a continuous

The rotation speed of the FSE tool can range from 500 to 1500 RPM, depending on factors such as the specific alloy, billet size, and desired properties. The axial pressure applied to the billet typically falls within the range of 10 to 50 kN (approximately 2,250 to 11,240 pounds) for aluminum alloys. The pressure is adjusted based on the alloy's hardness, billet size, and extrusion requirements. The design of the FSE tool, including the shape and dimensions of the pin and shoulder, can be customized for specific applications. Tool geometry affects the heat generation, material flow, and final shape of the extruded product. The die's shape and dimensions play a role in determining the final cross-sectional shape of the extruded material. Die design can be adjusted to produce various profiles, including round, square, rectangular, or complex geometries. The size of the initial cylindrical billet can vary widely based on the desired extruded product and application. FSE can be applied to both small and large billets.

### Additive Friction Stir Deposition (AFSD)

Additive Friction Stir Deposition (AFSD) is an advanced manufacturing technique that combines elements of friction stir welding (FSW) and additive manufacturing (AM) to create near-net-shaped components or to add material to existing structures. It is also sometimes referred to as “Friction Stir Additive Manufacturing” (FSAM). AFSD allows for the layer-by-layer deposition of material to build up complex structures, making it particularly suitable for manufacturing components with specific geometries and material properties.

Additive Friction Stir Deposition typically begins with a material feedstock, which can take multiple forms (i.e., solid bar, powder, wire). This feedstock is typically made of the desired alloy or material for the component being produced. The material is fed into the deposition zone. In some aspects described herein, the feedstock is an aluminum alloy, in particular a high-strength aluminum alloy. In some aspects, the feedstock includes an aluminum alloy that is substantially free of dispersoid particles. In some aspects, the feedstock includes an aluminum alloy that is substantially free of a metal selected from the group consisting of chromium, zirconium, and manganese. In some aspects, the feedstock includes high-strength aluminum alloys described herein.

The heart of AFSD is the friction stir process, which involves a rotating tool. This tool, typically shaped like a pin or probe, is inserted into the material, and it rotates at high speeds. As it rotates, it generates frictional heat and plasticizes the material without melting it. This plasticized material is then stirred together, ensuring a strong metallurgical bond.

In AFSD processing, the material is deposited layer by layer onto the substrate or previous layers. As the tool moves along a predetermined path, it lays down the material, fusing it to the underlying layers. The tool's rotation and translation are precisely controlled to achieve the desired geometry. As the newly deposited material cools down, it forms a solid bond with the previous layers. This process continues layer by layer until the desired part is complete.

### High-Strength Aluminum Alloys

High-strength aluminum alloys, including those from the 2000, 6000, and 7000 series, are often used in applications where strength and lightweight are important factors such as in aerospace and automotive applications.

### 6000 Series Aluminum Alloys:

The 6000 series aluminum alloys are a family of aluminum alloys that are versatile and widely used in various industries, including aerospace and automotive. These alloys are known for their excellent combination of strength, formability, and corrosion resistance. Here's a description of the 6000 series aluminum alloys, including the weight percentage range for common alloying elements and specific examples commonly used in aerospace and automotive applications:

Silicon is the primary alloying element in the 6000 series, typically ranging from 0.6% to 1.8% by weight. It enhances the alloy's strength and improves castability and fluidity during processing. Magnesium is another significant alloying element in the 6000 series, typically present in concentrations ranging from 0.4% to 1.2% by weight. Magnesium significantly enhances the alloy's strength, heat-treatability, and corrosion resistance. While not always present, copper may be added to some 6000 series alloys in smaller quantities (usually below 0.4% by weight) to further enhance strength and corrosion resistance.

Specific Examples of 6000 Series Alloys include the 6061 alloy, the 6063 alloy, and the 6005 alloy. The 6061 alloy is approximately 0.6% to 1.0% silicon, 0.2% to 0.6% magnesium, less than 0.25% copper. 6061 is a versatile alloy used in aerospace, automotive, and general engineering applications. It offers good strength, weldability, and corrosion resistance. It's commonly used in aircraft structures, automotive components, and bicycle frames.

The 6063 alloy is approximately 0.2% to 0.6% silicon, 0.45% to 0.9% magnesium. 6063 is known for its excellent extrudability and formability, making it ideal for extruded profiles. It is often used in architectural and automotive applications, such as window frames and structural components.

The 6005 alloy is approximately 0.6% to 1.0% silicon, 0.4% to 0.9% magnesium. 6005 is well-suited for applications requiring high strength and excellent extrudability. It is commonly used in aerospace for structural components.

### 7000 Series Aluminum Alloys:

The 7000 series aluminum alloys are a family of high-strength aluminum alloys known for their excellent mechanical properties and exceptional strength-to-weight ratios. These alloys are commonly used in aerospace, aviation, and high-performance automotive applications. Here's a description of the 7000 series aluminum alloys, including the weight percentage range for common alloying elements and specific examples like 7050 and 7075:

Zinc is the primary alloying element in the 7000 series, typically ranging from 5.7% to 8.2% by weight. Zinc contributes significantly to the alloy's strength and hardness. Magnesium is present in varying amounts, typically ranging from 1.2% to 2.1% by weight. Magnesium enhances strength, heat-treatability, and mechanical properties. Copper is another essential alloying element in the 7000 series, typically present in concentrations ranging from 1.2% to 2.0% by weight. Copper further enhances strength, hardness, and corrosion resistance. The 7000 series will conventionally contain trace elements like chromium (Cr) and zirconium (Zr) in small amounts, which are usually thought to improve mechanical properties and heat-treatability.

Specific examples of 7000 series alloys include the 7075 alloy and the 7050 alloy. The 7075 alloy is approximately 5.1% to 6.1% zinc, 2.1% to 2.9% magnesium, 1.2% to 2.0% copper, with traces of other elements. The 7050 alloy is approximately 5.7% to 6.7% zinc, 2.0% to 2.6% magnesium, 1.9% to 2.6% copper, with traces of other elements.

These specific examples, 7050 and 7075, are highly regarded for their exceptional mechanical properties and are commonly used in aerospace, aviation, and high-performance automotive components where lightweight materials with outstanding strength are required.

### Other Common Alloying Elements and Impurities

Chromium is often present in aluminum alloys in small amounts (usually less than 0.35%) to enhance corrosion resistance, particularly in harsh environments. Zirconium is conventionally used as a grain refiner to improve the mechanical properties and microstructure of aluminum alloys. Manganese is traditionally added to some aluminum alloys to improve strength and workability. It is typically present in amounts less than 1%.

Common impurities in aluminum alloys include iron (Fe), which is typically limited to less than 0.35%, and other trace elements like titanium (Ti), vanadium (V), and nickel (Ni), which are present in small amounts and can vary depending on the source and manufacturing process.

The specific composition of high-strength aluminum alloys can vary based on the alloy grade and intended application. Manufacturers carefully control the alloying elements and impurities to meet the desired strength, corrosion resistance, and other properties required for aerospace and automotive applications.

### Metal Articles

Metal articles are also provided that are made by the methods described herein. The methods can result in articles with enhanced strength as compared to the same article prepared with a conventional high-strength aluminum alloy.

High-strength aluminum alloys are extensively used in both the aerospace and automotive industries for a wide range of components and structures that require lightweight materials with exceptional strength and durability.

The article can include an aircraft fuselage, wing, landing gear, frames, bulkheads, and engine components. High-strength aluminum alloys, such as 7075 and 2024, are often used in the construction of aircraft fuselages. These alloys provide the required strength to withstand structural loads while keeping the weight of the aircraft relatively low. Wing components, including wing skins, spars, and ribs, are often made from high-strength aluminum alloys. These alloys offer the necessary strength-to-weight ratio and corrosion resistance for efficient and safe flight. Landing gear components, such as struts and wheels, frequently incorporate high-strength aluminum alloys. These alloys can withstand the stresses of takeoff, landing, and taxiing while keeping weight to a minimum. Structural frames and bulkheads in aircraft are commonly constructed using high-strength aluminum alloys. These components contribute to the overall rigidity and strength of the aircraft structure. Some high-strength aluminum alloys are used in engine components like housings and casings, where a balance of strength and weight is crucial for aviation efficiency.

The article can include an automotive wheels, suspension components, engine blocks, transmission housings, body panels, chassis components, and bumper reinforcements. High-strength aluminum alloys are widely used for manufacturing lightweight and durable automotive wheels. These alloys offer improved strength-to-weight ratios, enhancing vehicle performance and fuel efficiency. Certain suspension components, such as control arms and knuckles, are made from high-strength aluminum alloys. These components must withstand various loads while minimizing unsprung mass. Some high-performance and racing engines feature aluminum engine blocks made from high-strength alloys. These blocks offer strength and weight advantages, contributing to improved engine efficiency. Automatic and manual transmission housings in modern vehicles often incorporate high-strength aluminum alloys, reducing overall vehicle weight and increasing fuel economy. In some cases, aluminum body panels, particularly for luxury and high-performance vehicles, are manufactured from high-strength alloys. These panels offer weight reduction and improved fuel efficiency. Chassis components, including cross members and subframes, may be constructed using high-strength aluminum alloys. These components enhance vehicle stiffness and safety while reducing weight. Aluminum alloys with high strength are used for bumper reinforcements, enhancing collision protection while minimizing weight.

High-strength aluminum alloys are selected for these applications in the aerospace and automotive industries to strike a balance between structural integrity, weight reduction, and improved performance. These alloys play a crucial role in achieving lightweight and fuel-efficient vehicles and aircraft without compromising safety and strength.

### Methods

Unless prescribed elsewhere in the disclosure, or common sense would dictate otherwise, the methods, procedures, and protocols used in the present disclosure are more fully described below. The methods, procedures, and protocols defined below will be readily understood by those skilled in the relevant art, upon reading the instant disclosure. For the sake of brevity, not all steps, reaction conditions, protocols, or procedures may be specified where they are understood to be readily ascertainable or derivable by those skilled in the art upon reading the disclosure.

### Vickers Hardness Test

The Vickers hardness test provides a quantitative measure of the aluminum alloy's hardness based on the size of the indentation created by the diamond indenter. This method is widely used for its accuracy and is suitable for various materials, including aluminum alloys, to assess their mechanical properties and quality. The test involves using a Vickers hardness testing machine that applies a controlled force to the diamond indenter and measures the resulting indentation. The diamond indenter is a pyramidal diamond-shaped indenter with a square base (136 degrees between opposite faces) is used for the Vickers hardness test. A clean and flat surface of the aluminum alloy sample is prepared. The sample is placed securely on the texting machine's stage. The diamond indenter is positioned over the desired location on the specimen's surface and the load is gradually applied over a few seconds to minimize shock to the specimen. The load is maintained for the prescribed dwell time, typically ranging from 10 to 15 seconds. Common loads are typically 1 kgf, 5 kgf, or 10 kgf. The load is gradually released to zero within a few seconds to avoid disturbing the indentation. Using the calibrated microscope, the diagonals of the resulting Vickers indentation are measured. Measure from point to point on the edges, taking care to avoid parallax errors. The average of the two diagonal lengths is calculated, and the Vickers hardness (HV) is calculated using the formula: HV=1.8544*(F/d\hat{ }2), where F is the applied load (in kgf) and d is the average diagonal length (in mm).

### Quasi-Static Tension Test by ASTM Standard E8

The quasi-static tension test, as described by ASTM (American Society for Testing and Materials) standard E8, is a common method for determining the mechanical properties of materials, including aluminum alloys. This test provides valuable information about a material's tensile strength, yield strength, elongation, and other mechanical characteristics under quasi-static (slow, steady) loading conditions. The aluminum alloy specimen is machined to the required dimensions specified in the ASTM E8 standard. The specimen typically has a specific dog-bone shape. The specimen is placed in the grips of the tensile testing machine. A small preload is applied to the specimen to remove any slack and ensure it is properly seated in the grips. The specimen is aligned within the machine to ensure that the load is applied axially along the longitudinal axis of the specimen. The test parameters are set on the testing machine, including the test speed (usually slow for quasi-static tests), initial grip separation, and data acquisition rate. The test is begun by gradually displacing at a constant rate (typically specified in ASTM E8). The test speed should be slow enough to capture accurate data points during the test. The load is applied until the specimen fails (fractures). This failure point provides important information about the material's ultimate tensile strength. The recorded data is used to construct a stress-strain curve for the aluminum alloy specimen, which can be used to calculate various mechanical properties, such as tensile strength, yield strength, elongation, and modulus of elasticity, from the stress-strain curve. The quasi-static tension test conducted in accordance with ASTM standard E8 provides valuable information about an aluminum alloy's mechanical behavior under tensile loading conditions, making it a crucial test for material characterization and quality assurance in various industries.

### ASPECTS OF THE DISCLOSURE

The present disclosure will be better understood upon reading the following numbered aspects, which should not be confused with the claims. In some instance, the aspects below may be combined with one or more additional aspects or with other aspects described elsewhere in the disclosure and accompanying examples. All such variations and combinations are intended to be covered by the instant disclosure.
Aspect 1. A method of forming a metal article, the method including subjecting an aluminum alloy to a high strain rate severe plastic deformation (SPD) process to form a prefinished article; and heating the prefinished article to an elevated temperature for a period of time to form the article; wherein the aluminum alloy is a high-strength aluminum alloy comprising aluminum and one or more of copper, magnesium, and zinc; and wherein the aluminum alloy is substantially free of a metal selected from the group consisting of chromium, zirconium, and manganese.
Aspect 2. The method of any one of Aspects 1-32, wherein the high strain rate is characterized by a strain rate of from about 1/sec to about 1000/sec; or from about 1/sec to about 500/sec; or from about 1/sec to about 100/sec.
Aspect 3. The method of any one of Aspects 1-32, wherein the elevated temperature is from about 400° C. to about 600° C.
Aspect 4. The method of any one of Aspects 1-32, wherein the aluminum alloy contains zinc. Aspect 5. The method of any one of Aspects 1-32, wherein the period of time is equal to or greater than about 0.25 hours
Aspect 6. The method of any one of Aspects 1-32, wherein the alloy contains zinc and one or both of magnesium and copper.
Aspect 7. The method of any one of Aspects 1-32, wherein the aluminum alloy is characterized by a hardness of from about 150 HV to about 250 HV when measured according to a Vickers hardness test.
Aspect 8. The method of any one of Aspects 1-32, wherein the aluminum alloy is characterized by tensile yield strength of from about 450 MPa to about 750 MPa, and/or wherein the aluminum alloy is characterized by an ultimate tensile strength of from about 400 MPa to about 800 MPa, when measured according to a quasi-static tension test by ASTM standard E8.
Aspect 9. The method of any one of Aspects 1-32, wherein the aluminum alloy is characterized by a ductility of from about 6% to about 22% when measured by extensometer gauge.
Aspect 10. The method of any one of Aspects 1-32, wherein the aluminum alloy contains about 0.18% chromium by weight or less.
Aspect 11. The method of any one of Aspects 1-32, wherein the w/w ratio of chromium to aluminum is from about 10⁻⁷ to about 10⁻¹.
Aspect 12. The method of any one of Aspects 1-32, wherein the w/w ratio of chromium to aluminum is from about 10⁻⁷ to about 10⁻².
Aspect 13. The method of any one of Aspects 1-32, wherein the w/w ratio of chromium to aluminum is from about 10⁻⁷ to about 10⁻³.
Aspect 14. The method of any one of Aspects 1-32, wherein the w/w ratio of chromium to aluminum is from about 10⁻⁷ to about 10⁻⁴.
Aspect 15. The method of any one of Aspects 1-32, wherein the w/w ratio of chromium to aluminum is from about 10⁻⁷ to about 10⁻⁶.
Aspect 16. The method of any one of Aspects 1-32, wherein the w/w ratio of manganese to aluminum is from about 10⁻⁷ to about 10^{-0.7}, or from about 10⁻⁷ to about 10^{-0.75}.
Aspect 17. The method of any one of Aspects 1-32, wherein the w/w ratio of manganese to aluminum is from about 10⁻⁷ to about 10^{-0.8}.
Aspect 18. The method of any one of Aspects 1-32, wherein the w/w ration of manganese to aluminum is from about 10⁻⁷ to about 10^{-0.9}, or from about 10⁻⁷ to about 10⁻¹.
Aspect 19. The method of any one of Aspects 1-32, wherein the w/w ratio of manganese to aluminum is from about 10⁻⁷ to about 10⁻².
Aspect 20. The method of any one of Aspects 1-32, wherein the w/w ratio of manganese to aluminum is from about 10⁻⁷ to about 10⁻³.
Aspect 21. The method of any one of Aspects 1-32, wherein the w/w ratio of manganese to aluminum is from about 10⁻⁷ to about 10⁻.
Aspect 22. The method of any one of Aspects 1-32, further comprising from about 0.001% w/w to about 0.01% w/w of nickel.
Aspect 23. The method of any one of Aspects 1-32, wherein the alloy further contains iron.
Aspect 24. The method of any one of Aspects 1-32, wherein the alloy further contains copper.
Aspect 25. The method of any one of Aspects 1-32, wherein the high-strain rate SPD process is a friction stir welding (FSW).
Aspect 26. The method of any one of Aspects 1-32, wherein the high-strain rate SPD process is a Friction Stir Extrusion (FSE) process.
Aspect 27. The method of any one of Aspects 1-32, wherein the high-strain rate SPD process is an Additive Friction Stir Deposition (AFSD) process.
Aspect 28. The method of any one of Aspects 1-32, wherein the w/w ratio of zirconium to aluminum is from about from about 10⁻⁷ to about 10^{-0.92}
Aspect 29. The method of any one of Aspects 1-32, wherein the w/w ratio of zirconium to aluminum is from about 10⁻⁷ to about 10⁻¹.
Aspect 30. The method of any one of Aspects 1-32, wherein the w/w ratio of zirconium to aluminum is from about 10⁻⁷ to about 10^{-1.5}.
Aspect 31. The method of any one of Aspects 1-32, wherein the w/w ratio of zirconium to aluminum is from about 10⁻⁷ to about 10⁻².
Aspect 32. The method of any one of Aspects 1-31, wherein the w/w ratio of zirconium to aluminum is from about 10⁻⁷ to about 10⁻³.
Aspect 33. An article formed by a process according to any one of claims 1-32.
Aspect 34. The article of any one of Aspects 33-56, wherein the aluminum alloy contains about 0.18% chromium by weight or less.
Aspect 35. The article of any one of Aspects 33-56, wherein the w/w ratio of chromium to aluminum is from about 10⁻⁷ to about 10⁻¹.
Aspect 36. The article of any one of Aspects 33-56, wherein the w/w ratio of chromium to aluminum is from about 10⁻⁷ to about 10⁻².
Aspect 37. The article of any one of Aspects 33-56, wherein the w/w ratio of chromium to aluminum is from about 10⁻⁷ to about 10⁻³.
Aspect 38. The article of any one of Aspects 33-56, wherein the w/w ratio of chromium to aluminum is from about 10⁻⁷ to about 10⁻⁴.
Aspect 39. The article of any one of Aspects 33-56, wherein the w/w ratio of chromium to aluminum is from about 10⁻⁷ to about 10⁻⁶.
Aspect 40. The article of any one of Aspects 33-56, wherein the w/w ratio of manganese to aluminum is from about 10⁻⁷ to about 10⁻³.
Aspect 41. The article of any one of Aspects 33-56, wherein the w/w ratio of manganese to aluminum is from about 10⁻⁷ to about 10⁻⁴.
Aspect 42. The article of any one of Aspects 33-56, wherein the w/w ratio of manganese to aluminum is from about 10⁻⁷ to about 10⁻⁵.
Aspect 43. The article of any one of Aspects 33-56, wherein the w/w ratio of manganese to aluminum is from about 10⁻⁷ to about 10⁻⁴.
Aspect 44. The article of any one of Aspects 33-56, wherein the w/w ratio of manganese to aluminum is from about 10⁻⁵ to about 10⁻⁴.
Aspect 45. The article of any one of Aspects 33-56, further comprising from about 0.001% w/w to about 0.01% w/w of nickel.
Aspect 46. The article of any one of Aspects 33-56, wherein the alloy further contains iron.
Aspect 47. The article of any one of Aspects 33-56, wherein the alloy further contains copper.
Aspect 48. The article of any one of Aspects 33-56, wherein the high-strain rate SPD process is a friction stir welding (FSW).
Aspect 49. The article of any one of Aspects 33-56, wherein the high-strain rate SPD process is a Friction Stir Extrusion (FSE) process.
Aspect 50. The article of any one of Aspects 33-56, wherein the high-strain rate SPD process is an Additive Friction Stir Deposition (AFSD) process.
Aspect 51. The article of any one of Aspects 33-56, wherein the alloy contains by weight percent: 0.071 Silicon, 0.098 iron, 1.739 copper, 0.002 manganese, 2.501 magnesium, <0.002 chromium, 0.007 nickel, 5.614 zinc, 0.005 titanium and aluminum to the balance to 100.000%.
Aspect 52. The article of any one of Aspects 33-56, wherein the w/w ratio of zirconium to aluminum is from about from about 10⁻⁷ to about 10^{-0.92}.
Aspect 53. The article of any one of Aspects 33-56, wherein the w/w ratio of zirconium to aluminum is from about 10⁻⁷ to about 10⁻¹.
Aspect 54. The article of any one of Aspects 33-56, wherein the w/w ratio of zirconium to aluminum is from about 10⁻⁷ to about 10^{-1.5}.
Aspect 55. The article of any one of Aspects 33-56, wherein the w/w ratio of zirconium to aluminum is from about 10⁻⁷ to about 10⁻².
Aspect 56. The article of any one of Aspects 33-55, wherein the w/w ratio of zirconium to aluminum is from about 10⁻⁷ to about 10⁻³.

### EXAMPLES

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

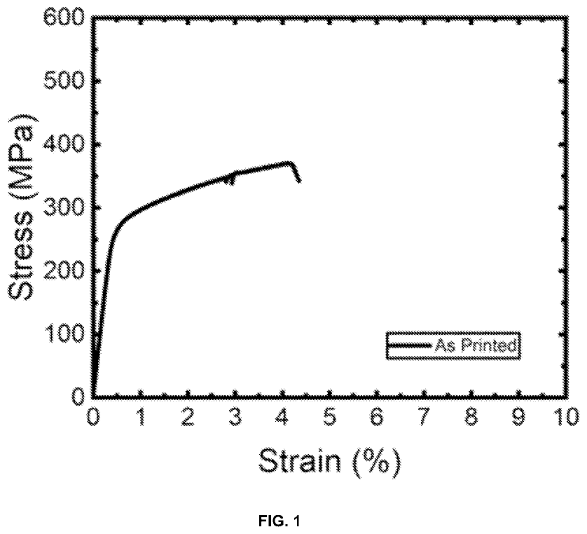

In this example, Al-7075 was printed to measure its as-printed properties. This is shown in FIG. 1. The as-printed strength is below that of the original wrought material due to the high thermal exposure during the AFSD process. This is the same phenomenon shown in Reference 1, but the loss of strength in this Example 1 is to a higher degree due to longer exposure time.

### Example 2

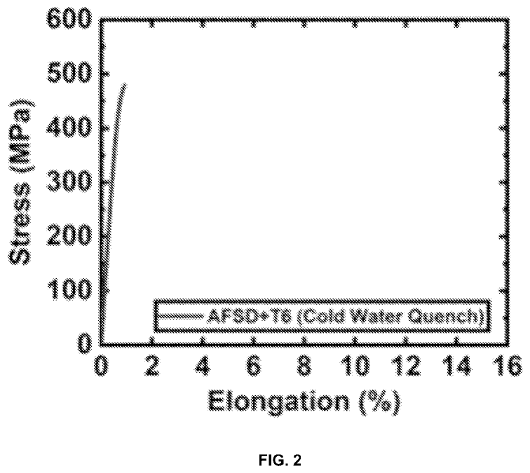

The as-printed material from Example 1 was subjected to a heat treatment. The tensile test results are shown in FIG. 2. The severe plastic deformation has changed the material and creates a brittle material after heat-treatment.

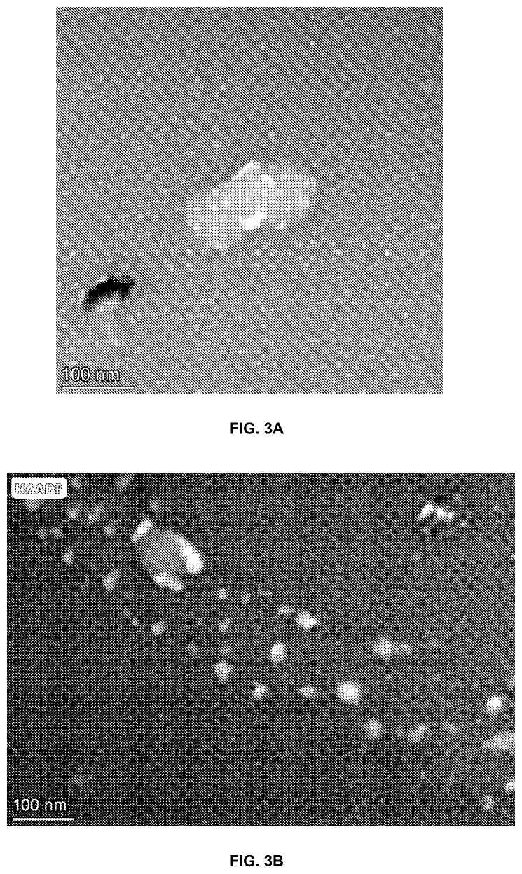

The strength of high strength aluminum alloys is generally due to a precipitate structure at the nanoscale. Transmission Electron Microscopy (TEM) characterization was conducted to understand the nature of the precipitates after AFSD. There was a stark difference between the precipitates around the dispersoid particles in Al-7075 in the AFSD material as compared to the stock material. For clarification, dispersoid particles are a secondary particle present in high strength aluminums to control the grain size during manufacturing. FIGS. 3A-3B show the precipitation on dispersoid particles in grain interiors in FIG. 3A and at grain boundaries in FIG. 3B. After AFSD it appears that the dispersoid particles have precipitates that are similar in size to the dispersoids. This is abnormal and is due to the dispersoid being potent heterogenous nucleation sites. This is true in stock Al-7075 aluminum, but there is a fundamental difference after the material undergoes severe plastic deformation.

To understand the effects of SPD on the dispersoid particles, high resolution TEM as well as Atomic Probe Tomography (APT) was conducted. The results of those experiments point to the dispersoids changing their nature after SPD due to the high shear stresses and a phenomenon called “Shear Induced Mixing”. This causes the dispersoids to create a non-equilibrium composition that turns them into a more potent nucleation site than typical Al-7075.

### Example 3

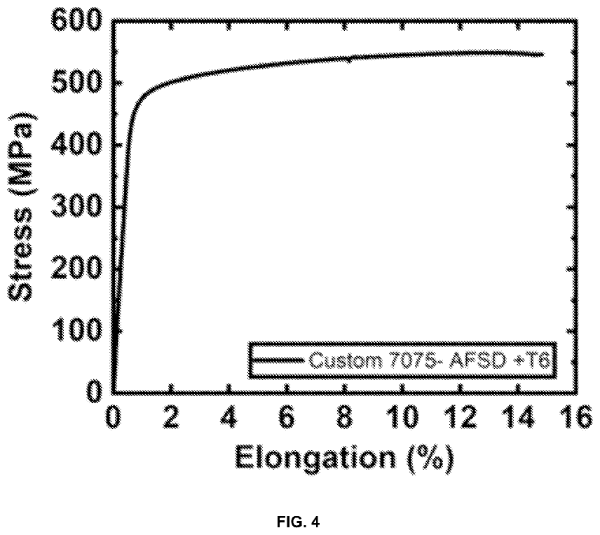

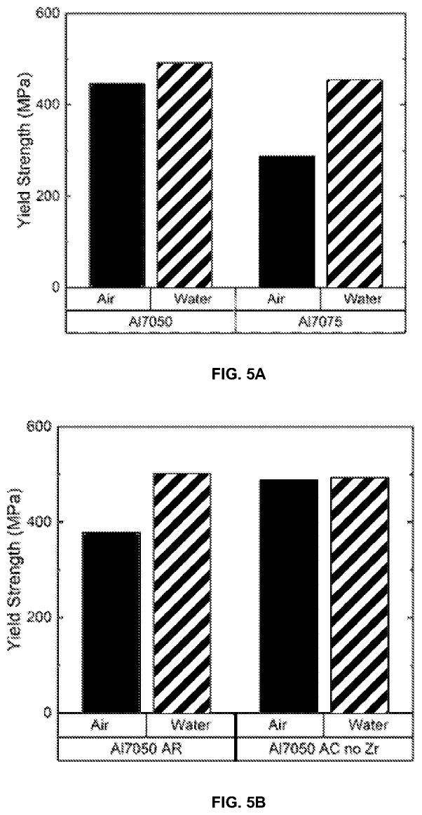

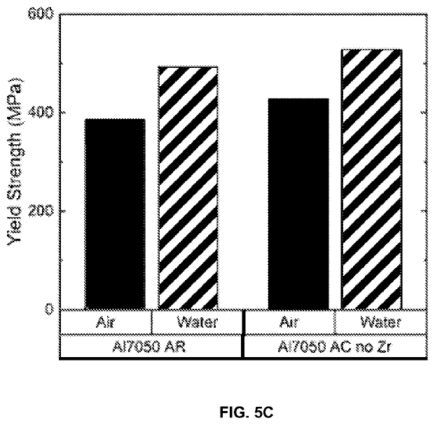

To study the effects of dispersoids on Al-7075, an alloy was cast with the same major alloying elements (Al, Zn, Mg, and Cu), but the Cr was omitted. The measured chemistry of this alloy is shown in Table 1 below. This alloy was subjected to the same AFSD process and subsequent heat treatment shown in FIG. 2. The resulting tensile results are shown in FIG. 4, indicating improvement in strength and ductility. The embrittlement phenomenon observed in all SPD processes thus may be related to a detrimental change in dispersoid particle characteristics; thus, such embrittlement appears to be ameliorated by removal of minor alloying elements.

TABLE 1
Minimum and Maximum Concentration of alloying elements
and impurities measured in the alloy of Example 3

| | Zn | Mg | Cu | *Fe | *Si |
|---|---|---|---|---|---|
| Min | 5.1 | 2.1 | 1.2 | 0 | 0 |
| Max | 6.1 | 2.9 | 2.0 | 0.5 | 0.4 |

*These are impurities not intentional alloying elements.

### Example 4

To further examine the dispersoid free 7xxx series aluminums, AA7050 was cast without the zirconium dispersoid additive. After AFSD, the yield strength of the dispersoid free material shows less influence to quench sensitivity compared to as-received AA7050 plus printing. Similar to the AA7075 results, this shows that severe plastic deformation is not compatible with the high strength aluminum alloys; specifically the dispersoid particles present in the matrix.

### REFERENCES

Unless specified elsewhere in the disclosure, references cited in the disclosure are enumerated below. References may be cited herein using the format of reference number(s) enclosed by parentheses corresponding to one or more of the following numbered references. References may also be cited herein using a superscript format. For example, citation of references number 1 immediately herein below could be indicated in the disclosure as Ref. (1) or as the superscript “(1)” or in any other format the would indicate the reference numbers below, as would be understood by the context. Similarly, a range of references may be expressed as Refs. (1)-(3), as Refs. (1), (2), and (3), or in similar format.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. Furthermore, any incorporation by reference of patents and patent applications to which the instant application claims priority is not intended to extend to any lexicographical definitions in the patents and patent applications so incorporated and should not be read as limiting the accompanying claims.

The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.
(1) S. V Sajadifar, G. Moeini, E. Scharifi, C. Lauhoff, S. Böhm, and T. Niendorf, “On the Effect of Quenching on Postweld Heat Treatment of Friction-Stir-Welded Aluminum 7075 Alloy,” J. Mater. Eng. Perform., vol. 28, no. 8, pp. 5255-5265, 2019.

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure. It is intended that the specification and examples be considered as exemplary only, with a true scope and spirit of the disclosure being indicated by the following claims.

We claim:

1. A method of forming a metal article, the method comprising:
a. subjecting an aluminum alloy to a high strain rate severe plastic deformation (SPD) process to form a prefinished article; and
b. heating the prefinished article to an elevated temperature for a period of time to form the article;
wherein the aluminum alloy is a high-strength aluminum alloy comprising aluminum and one or more of copper, magnesium, and zinc; and
wherein the aluminum alloy is substantially free of a metal selected from the group consisting of chromium, zirconium, and manganese.

2. The method of claim 1, wherein the high strain rate is characterized by a strain rate of from about 1/sec to about 1000/sec; or from about 1/sec to about 500/sec; or from about 1/sec to about 100/sec.

3. The method of claim 2, wherein the elevated temperature is from about 400° C. to about 600° C.

4. The method of claim 3, wherein the aluminum alloy comprises zinc.

5. The method of claim 4, wherein the period of time is equal to or greater than about 0.25 hours

6. The method of any one of claims 1-4, wherein the alloy comprises zinc and one or both of magnesium and copper.

7. The method of any one of claims 1-4, wherein the aluminum alloy is characterized by a hardness of from about 150 HV to about 250 HV when measured according to a Vickers hardness test.

8. The method of any one of claims 1-4, wherein the aluminum alloy is characterized by tensile strength of from about 450 MPa to about 750 MPa, and/or wherein the aluminum alloy is characterized by an ultimate tensile strength of from about 400 MPa to about 800 MPa, when measured according to a quasi-static tension test by ASTM standard E8.

9. The method of any one of claims 1-4, wherein the aluminum alloy is characterized by a ductility of from about 6% to about 22% when measured by extensometer gauge.

10. The method of any one of claims 1-4, wherein the aluminum alloy comprises about 0.18% chromium by weight or less.

11. The method any one of claims 1-4, wherein the w/w ratio of chromium to aluminum is from about 10⁻⁷ to about 10⁻¹.

12. The method any one of claims 1-4, wherein the w/w ratio of chromium to aluminum is from about 10⁻⁷ to about 10⁻².

13. The method any one of claims 1-4, wherein the w/w ratio of chromium to aluminum is from about 10⁻⁷ to about 10⁻³.

14. The method any one of claims 1-4, wherein the w/w ratio of chromium to aluminum is from about 10⁻⁷ to about 10⁻⁴.

15. The method any one of claims 1-4, wherein the w/w ratio of chromium to aluminum is from about 10⁻⁷ to about 10⁻⁶.

16. The method of any one of claims 1-4, wherein the w/w ratio of manganese to aluminum is from about 10⁻⁷ to about 10^{-0.7}, or from about 10⁻⁷ to about 10^{-0.75}.

17. The method of any one of claims 1-4, wherein the w/w ratio of manganese to aluminum is from about 10⁻⁷ to about 10^{-0.8}.

18. The method of any one of claims 1-4, wherein the w/w ration of manganese to aluminum is from about 10⁻⁷ to about 10^{-0.9}, or from about 10⁻⁷ to about 10⁻¹.

19. The method of any one of claims 1-4, wherein the w/w ratio of manganese to aluminum is from about 10⁻⁷ to about 10⁻².

20. The method of any one of claims 1-4, wherein the w/w ratio of manganese to aluminum is from about 10⁻⁷ to about 10⁻³.

21. The method of any one of claims 1-4, wherein the w/w ratio of manganese to aluminum is from about 10⁻⁷ to about 10⁻.

22. The method of any one of claims 1-4, further comprising from about 0.001% w/w to about 0.01% w/w of nickel.

23. The method of any one of claims 1-4, wherein the alloy further comprises iron.

24. The method of any one of claims 1-4, wherein the alloy further comprises copper.

25. The method of any one of claims 1-4, wherein the high-strain rate SPD process is a friction stir welding (FSW).

26. The method of any one of claims 1-4, wherein the high-strain rate SPD process is a Friction Stir Extrusion (FSE) process.

27. The method of any one of claims 1-4, wherein the high-strain rate SPD process is an Additive Friction Stir Deposition (AFSD) process.

28. The method of any one of claims 1-4, wherein the w/w ratio of zirconium to aluminum is from about from about 10⁻⁷ to about 10^{-0.92}

29. The method of any one of claims 1-4, wherein the w/w ratio of zirconium to aluminum is from about 10⁻⁷ to about 10⁻¹.

30. The method of any one of claims 1-4, wherein the w/w ratio of zirconium to aluminum is from about 10⁻⁷ to about 10^{-1.5}.

31. The method of any one of claims 1-4, wherein the w/w ratio of zirconium to aluminum is from about 10⁻⁷ to about 10⁻².

32. The method of any one of claims 1-4, wherein the w/w ratio of zirconium to aluminum is from about 10⁻⁷ to about 10⁻³.

33. An article formed by a process according to any one of claims 1-32.

34. The article of claim 33, wherein the aluminum alloy comprises about 0.18% chromium by weight or less.

35. The article of claim 33 or claim 34, wherein the w/w ratio of chromium to aluminum is from about 10⁻⁷ to about 10⁻¹.

36. The article of claim 33 or claim 34, wherein the w/w ratio of chromium to aluminum is from about 10⁻⁷ to about 10⁻².

37. The article of claim 33 or claim 34, wherein the w/w ratio of chromium to aluminum is from about 10⁻⁷ to about 10⁻³.

38. The article of claim 33 or claim 34, wherein the w/w ratio of chromium to aluminum is from about 10⁻⁷ to about 10⁻⁴.

39. The article of claim 33 or claim 34, wherein the w/w ratio of chromium to aluminum is from about 10⁻⁷ to about 10⁻⁶.

40. The article of claim 33 or claim 34, wherein the w/w ratio of manganese to aluminum is from about 10⁻⁷ to about 10⁻³.

41. The article of claim 33 or claim 34, wherein the w/w ratio of manganese to aluminum is from about 10⁻⁷ to about 10⁻⁴.

42. The article of claim 33 or claim 34, wherein the w/w ratio of manganese to aluminum is from about 10⁻⁷ to about 10⁻⁵.

43. The article of claim 33 or claim 34, wherein the w/w ratio of manganese to aluminum is from about 10⁻⁷ to about 10⁻⁴.

44. The article of claim 33 or claim 34, wherein the w/w ratio of manganese to aluminum is from about 105 to about 10⁻⁴.

45. The article of claim 33 or claim 34, further comprising from about 0.001% w/w to about 0.01% w/w of nickel.

46. The article of claim 33 or claim 34, wherein the alloy further comprises iron.

47. The article of claim 33 or claim 34, wherein the alloy further comprises copper.

48. The article of claim 33 or claim 34, wherein the high-strain rate SPD process is a friction stir welding (FSW).

49. The article of claim 33 or claim 34, wherein the high-strain rate SPD process is a Friction Stir Extrusion (FSE) process.

50. The article of claim 33 or claim 34, wherein the high-strain rate SPD process is an Additive Friction Stir Deposition (AFSD) process.

51. The article of claim 33 or claim 34, wherein the alloy comprises by weight percent: 0.071 Silicon, 0.098 iron, 1.739 copper, 0.002 manganese, 2.501 magnesium, <0.002 chromium, 0.007 nickel, 5.614 zinc, 0.005 titanium and aluminum to the balance to 100.000%.

52. The article of claim 33 or claim 34, wherein the w/w ratio of zirconium to aluminum is from about from about 10⁻⁷ to about 10^{-0.92}.

53. The article of claim 33 or claim 34, wherein the w/w ratio of zirconium to aluminum is from about 10⁻⁷ to about 10⁻¹.

54. The article of claim 33 or claim 34, wherein the w/w ratio of zirconium to aluminum is from about 10⁻⁷ to about 10^{-1.5}.

55. The article of claim 33 or claim 34, wherein the w/w ratio of zirconium to aluminum is from about 10⁻⁷ to about 10⁻².

56. The article of claim 33 or claim 34, wherein the w/w ratio of zirconium to aluminum is from about 10⁻⁷ to about 10⁻³.
